(19) United States
(12) Patent Application Publication
(10) Pub. No.: US 2010/0100834 A1
(43) Pub. Date: Apr. 22, 2010

(54) SYSTEM AND METHOD OF ONLINE CUSTOM DESIGN OF PRINTED OFFICE PRODUCTS

(76) Inventor: Darren MacDonald, Costa Mesa, CA (US)

Correspondence Address: AVERY DENNISON CORPORATION;Patent Group, Law Department - 3 South, P.O. BOX 7090, PASADENA, CA, 91109-7090, US

(21) Appl. No.: 12/255,630

(22) Filed: Oct. 21, 2008

(51) Int. Cl. G06F 3/048

(52) U.S. Cl. 715/764

(57) ABSTRACT

A software application that can be downloaded from a centralized server and execute within the web browser of an electronically linked computer is programmed to include a plurality of advanced editing tools to assist in the customized design of a printable office product, such as a binder, divider or the like. The software application also includes a panel selection tool that generates a graphical user interface (GUI) control for regulating on which printable surfaces of the office product a visual element in the active document is to be printed, the GUI control being in the form of a grid of uniquely patterned rows. The software application also includes an image size optimization tool for generating a warning indicator when the resolution of a resizable image element in the active document falls beneath a predefined resolution threshold of approximately 180 dpi.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND

The present invention relates generally to the custom design of printed office products, such as binders, dividers and the like, and more particularly to the interactive custom design of printed office products via the Internet.

Avery Dennison Corporation of Pasadena, Calif. is a worldwide leader in the manufacture and sale of printable office products, such as binders, dividers and the like. To enhance their appearance, certain printable office products are often mass produced in a plurality of stock colors and patterns.

It has been found that, in certain instances, consumers wish to uniquely identify printable office products. Accordingly, it is well known in the art for printed office products to be custom designed to include, inter alia, (i) a unique background design or pattern, (ii) one or more pictures, images and/or clipart, and (iii) names, dates and/or other relevant text. For example, the front cover of a three-ring binder to be disseminated at a corporate seminar may be customized to include, among other things, the name of the company, the date of the seminar, the title of the discussion and a full color, photo quality image relating to the seminar subject matter.

Traditionally, a print order for the custom design of printed office products is placed by a customer with a sales representative for the product manufacturer. Using the information provided by the customer to the sales representative, the manufacturer generates an electronic print file for the custom design. In certain instances, the manufacturer may generate a sample for the customer to review prior to printing to ensure satisfaction. If necessary, the customer may request modifications to the custom design, which are then incorporated into the print file by the manufacturer. The aforementioned review process is often repeated, as deemed necessary, until the customer is satisfied with the finished product.

Once the sample is accepted by the customer, the product manufacturer electronically transmits the print file to an affiliated print facility, which, in turn, prints the custom design on the specified office products. Upon completion of the printing process, the printed office products are then shipped to the customer in a timely manner, thereby completing execution of the order.

However, the aforementioned process for generating customized printed office products suffers from a few notable drawbacks.

As a first drawback, the manufacturer is required to staff a multitude of employees who are responsible for, among other things, fielding custom print requests and, in turn, creating an electronic print file in accordance with the request. As can be appreciated, this staffing requirement significantly increases manufacturer operating expenses, which is highly undesirable.

As a second drawback, in those circumstances in which a customer is not provided with the opportunity to review an accurate sample, the product manufacturer runs the risk that the customer will ultimately be dissatisfied with the finished product upon receipt. Consequently, if the customer is dissatisfied with the finished product, a modification of the print file and a subsequent re-execution of the entire print order is often required, thereby significantly increasing the overall printing costs, which is highly undesirable.

As a third drawback, in those circumstances in which the customer is provided with both a sample and the ability to request modifications, the overall process is rendered unduly time-consuming and expensive in nature, which is highly undesirable.

As a fourth drawback, manufacturers have costs associated with customization of printed office products that ultimately increases the costs to customers. The increased costs to customers can be in the form of minimum purchase requirements, which are often larger amounts of the product than the customer actually needs, or in the form of “set-up” costs, which cover the cost for the generation of digital artwork or making print plates and the additional proofing required. Frequently, manufacturers will require both.

In response to the aforementioned shortcomings, certain manufacturers in the office products retail industry have recently developed means for enabling customers to interactively design the electronic file used by a print facility to print products in accordance with an order. Specifically, an Internet-accessible server that is maintained by the manufacturer is provided with an editing program that can be downloaded by and to a customer computer via the Internet, the editing program preferably running within a conventional Internet browser program on the customer computer. In this manner, the customer is able to retrieve, examine and dynamically modify the print file stored on the manufacturer server prior to execution of the print order. By enabling the customer to directly partake in the design of the print file, the aforementioned online design system results in (i) a reduction in operating expenses, (ii) a greater likelihood of customer satisfaction and (iii) an improvement in the speed of the overall process, all of which are highly desirable.

Although widely used in the art, the interactive custom design of printable office products presently suffers from a pair of notable shortcomings.

As a first shortcoming, the editing programs utilized in the web-based design of printed office products presently offer consumers with limited tools for interactively modifying custom print files. As a result, the present process in which a consumer interactively edits a custom print design has been found to be both inadequate and time-consuming.

As a second shortcoming, the editing program utilized in the web-based design of printed office products often fails to accurately depict how the finished product will appear. Specifically, because a relatively small sized, two-dimensional computer screen is used to display a relatively large, three-dimensional object, consumers are often insufficiently apprised of how the finished product will appear.

Consumers may have alternatives to manufacturer-implemented customization of printed office products. For example, a consumer can insert a customized sheet of paper into a clear cover pocket of a binder in an effort to customize a binder, thereby avoiding the drawbacks and shortcomings described above. However, the appearance of the binder has less of a professional appearance than a binder customized by the manufacturer, and thus, having the cover pockets with inserted sheets of paper is generally not preferred.

### SUMMARY

As one feature of the present invention, there is provided a method of creating an electronic document to be used in the customized design of a printable office product, the method being implemented using a software application, the printable office product including first and second printable surfaces, the method including the steps of (a) opening an active file within the software application, the active file capable of supporting a visual element, (b) rendering a workspace for the active file within the software application, the workspace being formatted into first and second panels that correspond to the first and second printable surfaces of the printable office product, the first and second panels being separated by a partition line, the workspace including a visual element that extends across the partition line, the software application partitioning the visual element through the partition line and into first and second subsections, and (c) activating a panel selection tool within the software application, the panel selection tool regulating the display of any combination of the first and second subsections of the visual element within the workspace.

As another feature of the present invention, there is provided a method of the type as described above wherein the panel selection tool generates a graphical user interface (GUI) control for regulating the display of any combination of the first and second subsections of the visual element within the workspace.

As another feature of the present invention, there is provided a method of the type as described above wherein the panel selection tool generates a GUI control in the form of a grid of uniquely patterned rows, each row serving as an active control for displaying a unique combination of the first and second subsections.

As another feature of the present invention, there is provided a method of the type as described above wherein each row of the GUI control for the panel selection tool is displayed as a box that is partitioned into a pair of subsections so as to resemble the formatting attributes of the workspace in miniaturized form.

As another feature of the present invention, there is provided a method of the type as described above wherein the subsections of each row of the GUI control are displayed as exactly one of shaded and white.

As another feature of the present invention, there is provided a method of the type as described above wherein the software application is designed to generate a three-dimensional rendering of the active file displayed on the workspace.

As another feature of the present invention, there is provided a method of the type as described above wherein the software application provides a pair of graphical user interface controls for rotating the three-dimensional rendering.

As another feature of the present invention, there is provided a method of the type as described above wherein the visual element represents one of a background element, a text element and an image element.

As another feature of the present invention, there is provided a method of the type as described above further including the step of, after the activating step, saving the active file depicted in the workspace of the software application to yield the electronic document to be used in the customized design of the printable office product.

As another feature of the present invention, there is provided a method of the type as described above further including the steps of, prior to the opening step, (a) accessing a centralized server having stored thereon the software application for creating the electronic document, (b) downloading the software application from the centralized server to a customer computer, and (c) executing the software application within a web browser in the customer computer to create the electronic document.

As another feature of the present invention, there is provided a method of the type as described above wherein the visual element is in the form of an image element, the image element having a measurable resolution.

As another feature of the present invention, there is provided a method of the type as described above wherein the software application includes controls for resizing the image element.

As another feature of the present invention, there is provided a method of the type as described above further including the steps of, after the rendering step, (a) comparing the measurable resolution of the image element against a predefined resolution threshold, and (b) generating a warning indicator on the workspace when the resolution of the image element falls beneath the predefined resolution threshold.

As another feature of the present invention, there is provided a method of the type as described above wherein the predefined resolution threshold is approximately 180 dpi.

As another feature of the present invention, there is provided a method of the type as described above wherein the software application includes controls that are configured to act upon the first subsection of the visual element.

As another feature of the present invention, there is provided a method of creating an electronic document to be used in the customized design of a printable office product, the method being implemented using a software application, the method including the steps of (a) opening an active file within the software application, the active file capable of supporting an image element, (b) rendering a workspace for the active file within the software application, the workspace including an image element, the image element having a measurable resolution, the software application including controls for resizing the image element, (c) comparing the measurable resolution of the image element against a predefined resolution threshold, and (d) generating a warning indicator on the workspace when the resolution of the image element falls beneath the predefined resolution threshold.

As another feature of the present invention, there is provided a method of the type as described above wherein the predefined resolution threshold is approximately 180 dpi.

Various other features and advantages will appear from the description to follow. In the description, reference is made to the accompanying drawings that form a part thereof, and, in which, is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified block diagram of a system for the online custom design of printed office products, the system being configured according to the teachings of the present invention;

FIGS. 2(a)-(e) are a series of sample screen displays for a software application designed for use in connection with the system of FIG. 1, the software application being designed according to the teachings of the present invention, the software application enabling a customer to interactively design an electronic print file that can be used to customize a printable office product;

FIGS. 3(a)-(h) are a series of sample screen displays for the software application of FIG. 2(a), the sample screen displays being useful in understanding a panel selection tool that operates as part of the software application; and

FIGS. 4(a)-(b) are a series of sample screen displays for the software application of FIG. 2(a), the sample screen displays being useful in understanding an image size optimization tool that operates as part of the software application.

### DETAILED DESCRIPTION

### System for Online Custom Design of Printed Office Products

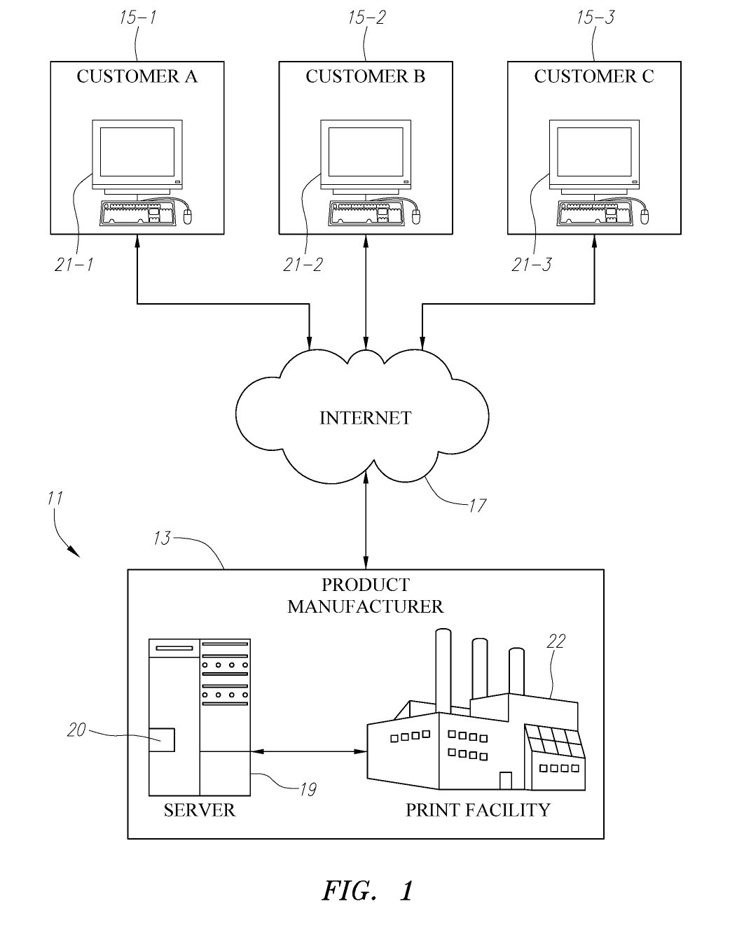

Referring now to FIG. 1, there is shown a simplified block diagram of a system for the online custom design of printed office products, the system being configured according to the teachings of the present invention and identified generally by reference numeral 11. As defined herein, use of the term “printed office products” denotes any office product on which a customized design can be printed. Examples of printed office products include binders, dividers and the like. For purposes of simplicity only, the system and method of the present invention will be shown herein in connection with the customized design of a 1.5 inch, three-ring binder. However, it should be noted that the present invention is not limited to the custom design of binders. Rather, it is to be understood that the present invention could be similarly utilized in conjunction with the design of alternative types of printable office products, such as dividers and the like, without departing from the spirit of the present invention.

As can be seen, system 11 enables a single manufacturer of printable office products 13 to be electronically linked with a plurality of independent customers (also referred to as users) 15-1, 15-2 and 15-3 via the Internet 17. Specifically, manufacturer 13 either directly or remotely maintains a centralized server 19, which can be accessed through the Internet 17. In addition, customers 15-1, 15-2 and 15-3 (also identified herein as Customer A, Customer B and Customer C, respectively) are provided with web-enabled computers 21-1, 21-2 and 21-3, respectively. In this manner, each customer 15 is able to access server 19 via the Internet 17.

As will be described in detail below, the present invention enables each customer 15 to create a customized print file that is directed by server 19 to an affiliated print facility 22. Using the customized print file, print facility 22 customizes office products in compliance with a designated print order.

### Overview of the Present Method of Online Custom Design

A novel software application that can be used to create a customized print file for printed office products is stored in a computer-readable medium 20 within server 19, the software application being designed according to the teachings of the present invention and identified generally by reference numeral 23. As defined herein, computer-readable medium 20 represents any nonvolatile storage device (e.g., an internal or external hard drive) that is electronically coupled to server 19.

Preferably, the software application 23 is capable of being downloaded from server 19 by and to a customer computer 21 through the Internet 17. For example, the software application 23 may be coded in a particular multimedia authoring program (e.g., Adobe Flash Player v. 9.0) that is downloaded and runs within a conventional web browser application on a customer computer 21.

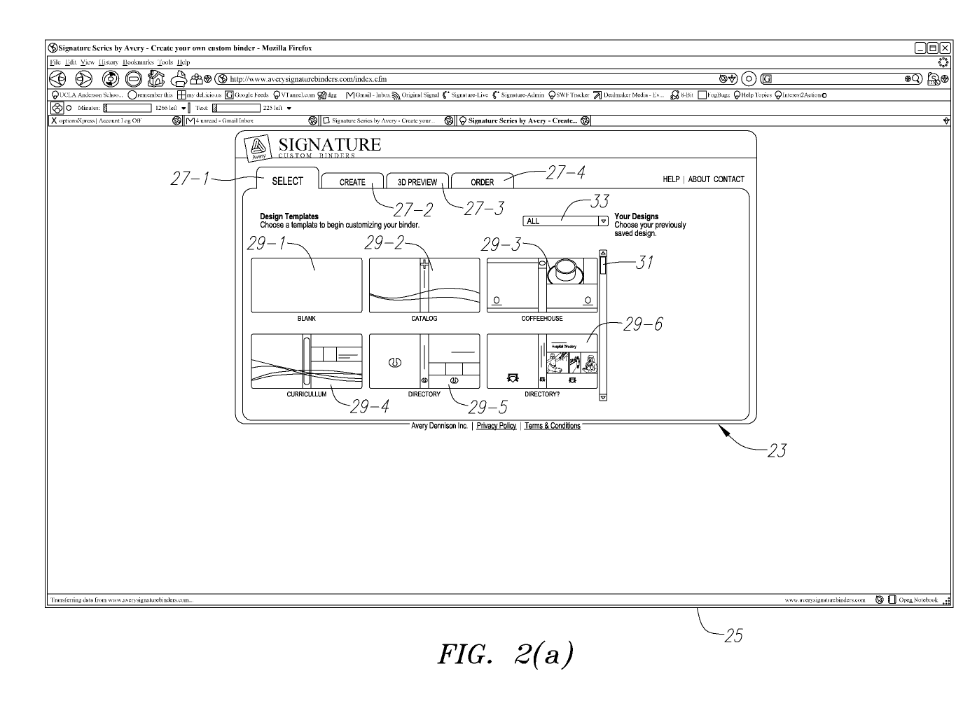

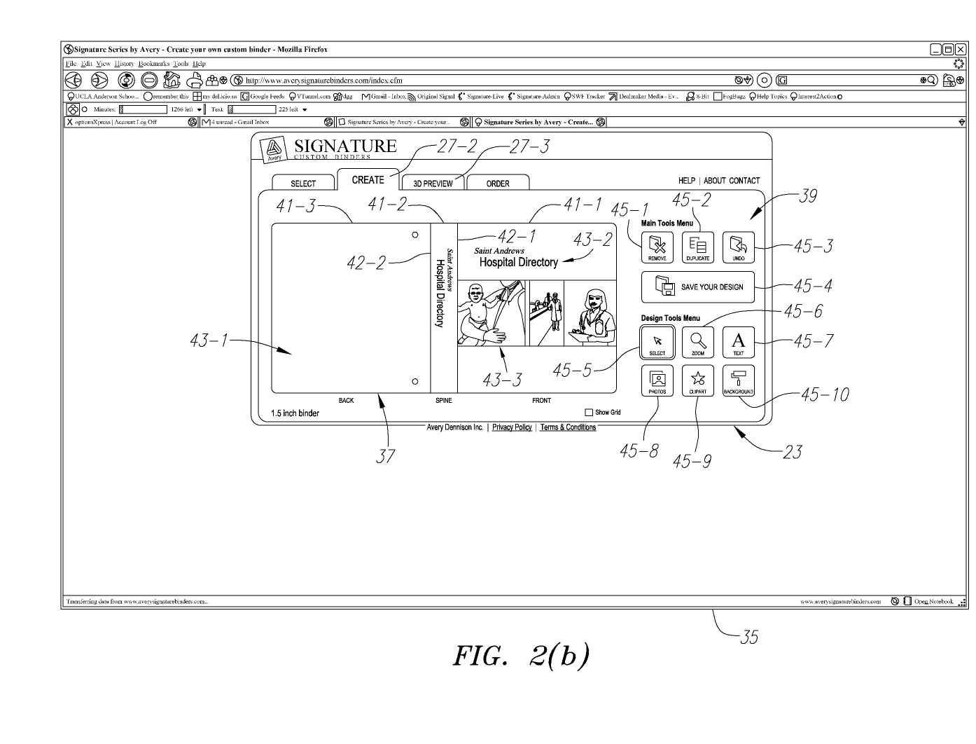

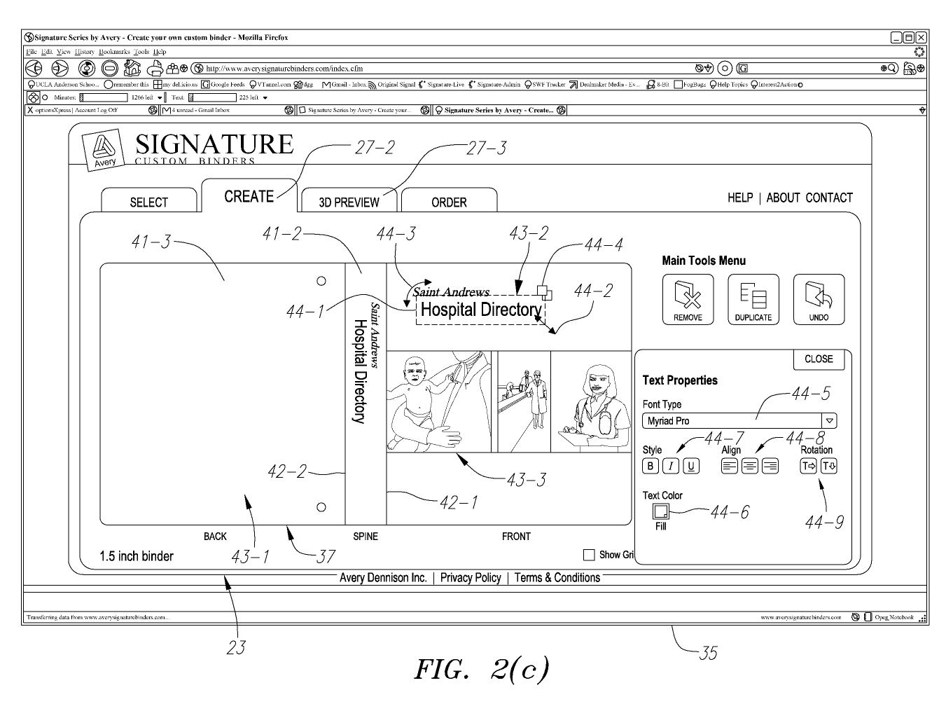

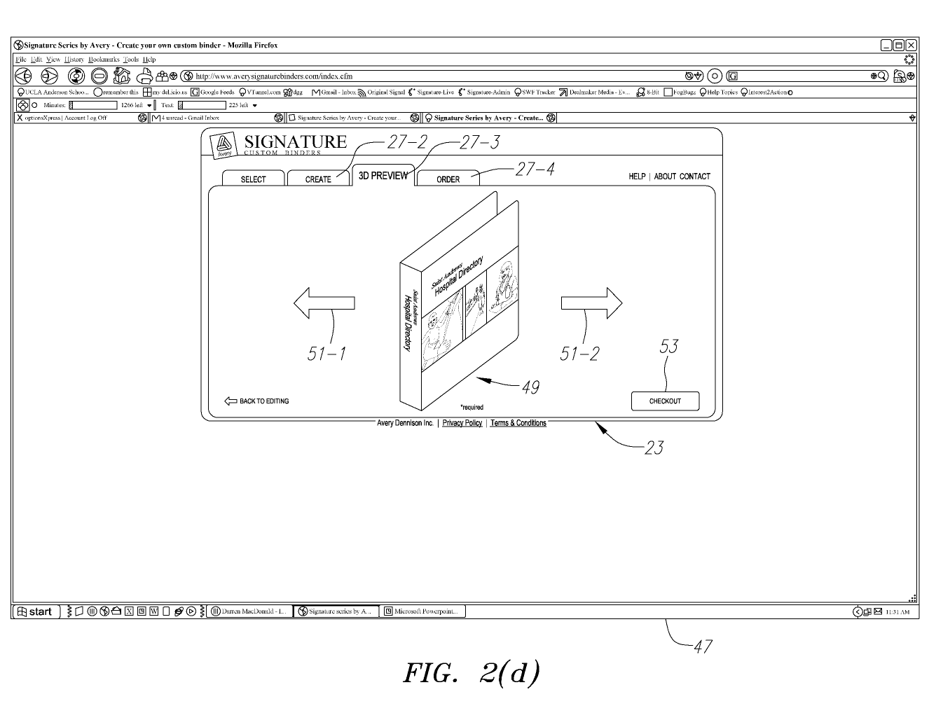

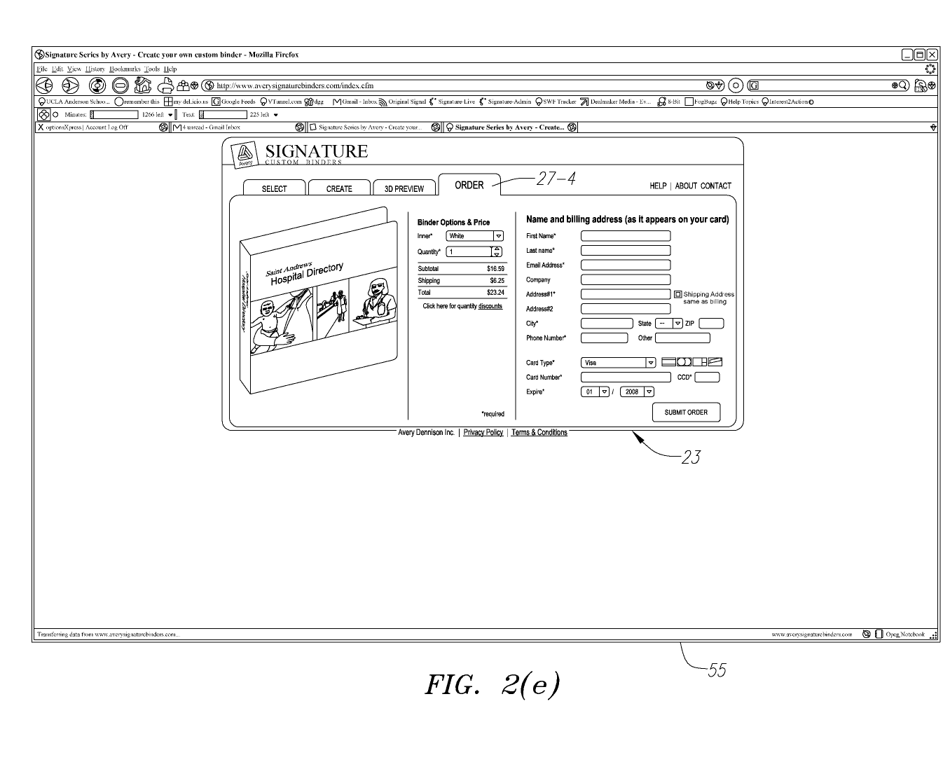

Referring now to FIGS. 2(a)-(d), there is shown a series of sample screen displays for the software application 23 that are useful in understanding the general process by which application 23 enables a customer 15 to create an electronic print file, which is, in turn, utilized by print facility 22 to customize the design of a printable office product.

Upon initialization of application 23 by the customer 15, the sample screen display shown in FIG. 2(a) is presented on the screen of the customer computer 21, the screen display being identified generally by reference numeral 25. As can be seen, the software application 23 includes a plurality of task-based functionality tabs 27-1 thru 27-4, which are layered, or stacked, so that the contents of at most one tab 27 is viewable at a time. More specifically, the software application 23 includes a select tab 27-1, a create tab 27-2, a 3D preview tab 27-3 and an order tab 27-4. It should be noted that tabs 27 are layered, left to right, to replicate the preferred sequence of the custom design process. As can be seen, the select tab 27-1 is opened upon initialization of application 23.

With the select tab 27-1 opened, the user is able to select any one of an array of pre-designed templates 29, e.g., templates 29-1 thru 29-6 being shown herein. As will be described further in detail below, each template 29 includes a predefined arrangement of background, text and/or image related elements, thereby providing the user with a professional-looking starting point from which to create a printable design. Although not shown herein, personalized templates that have been created and saved by the user are similarly provided for selection (i.e., under the heading “Your Designs”).

For greater ease in reviewing available templates 29, a vertical scroll bar 31 is provided. In addition, a drop down window 33 is provided that groups the various templates 29 into selected categories (e.g., business, general, industry, IT, kitchen, medical, restaurant, school). To select a particular template 29, the user clicks directly on the template image. In turn, the software application 23 opens an active file using the selected template 29, the active file being displayed within the create tab 27-2 for editing purposes.

Referring now to FIG. 2(b), there is shown a sample screen display 35 for an active file created using template 29-6, the active file being shown with the create tab 27-2 opened for editing purposes. As can be seen, the create tab 27-2 includes an active workspace 37 and a tools menu 39.

The workspace 37 provides an enlarged, two-dimensional representation of the active file as it will appear when printed on the intended office product. In the present example, the active file is shown formatted for printing on a 1.5 inch three ring binder.

As can be seen, the software application 23 formats the active workspace 37 into a plurality of discrete panels 41, with adjacent panels 41 being separated by vertical partition lines 42. It is to be understood that each panel 41 represents a particular printable surface on the designated office product. For example, in connection with the design of the 1.5 inch binder shown herein, the workspace 37 is formatted to include a front panel 41-1, a spine panel 41-2 and a back panel 41-3, with the front panel 41-1 and the spine panel 41-2 being separated by partition line 42-1 and the spine panel 41-2 and the back panel 41-3 being separated by partition line 42-2. In this manner, the user can view the entirety of the active file.

In the present example, partition lines 42 are visibly displayed on the active workspace 37. However, it is to be understood that partition lines 42 could be functionally active but visibly hidden on the workspace 37 without departing from the spirit of the present invention.

The software application (also referred to as a program) 23 is designed such that the active file displayed in the workspace 37 is capable of supporting a variety of different visual elements 43 that can be modified and/or repositioned at any location in the workspace 37. As defined herein, “visual elements” 43 encompasses (i) a background element 43-1, which may be in the form of an intricate, multi-colored background design or pattern; (ii) one or more text elements 43-2, which can be used, inter alia, to identify the subject matter of the office product (e.g., “Hospital Directory”); and (iii) one or more image elements 43-3 (e.g., photographs, clip art or other similar images), which may be in the form of, inter alia, a high quality, full-color photograph relevant to the subject matter of the product. Together, the ability to select, modify and arrange the visual elements 43 on the workspace 37 allows for the production of a detailed, professional-style custom design.

As seen most clearly in FIG. 2(c), by clicking directly on a particular text element 43-2, a visible text box 44-1 appears around the text element 43-2 along with a pop-up of various text related controls that assist in the modification of the activated text element 43-2. Examples of preferred text related controls include, but are not limited to, a text box resizing tool 44-2, a text box rotation tool 44-3, a text box order tool 44-4 (i.e., for moving the text box forward or backward in relation to other elements), a font type pull-down window 44-5 for changing the font of the text, a text color icon 44-6 for activating a palette for changing the text color, text style tools 44-7 (e.g., bold, italic and underline), text alignment tools 44-8 (e.g., left, right and center) and text orientation tools 44-9 (e.g., vertical or horizontal).

Similarly, it should be noted that by clicking directly on a particular image element 43-3, a visible picture box appears around the image element 43-3 along with a pop-up of various image related controls that assist in the modification of the activated image element 43-3. Examples of preferred image related controls include, but are not limited to, an image resizing tool, a image rotation tool and an image order tool (i.e., for moving the image box forward or backward in relation to other elements), as will be discussed in greater detail below. Additionally, controls can be configured to act upon an entire image, or only portions of an image, in particular, portions of an image within a selected panel. For example, the portion of an image in a selected panel can be converted to black and white, while the portion of the image not in the selected panel is in color.

Referring back to FIG. 2(b), to further assist the user in the process of redesigning the active file displayed on the workspace 37, the create tab 27-2 includes a tool menu 39 having a plurality of different functionality controls 45, each functionality control 45 being preferably displayed as a user-intuitive icon. Specifically, the tools menu 39 includes: (i) a remove button 45-1 for deleting a selected text element 43-2 or image element 43-3 from the workspace 37; (ii) a duplicate button 45-2 for copying a selected text element 43-2 or image element 43-3 onto the workspace 37; (iii) an undo button 45-3 for undoing (i.e., changing back) the last edit to the active file; (iv) a save button 45-4 for saving the active file as a personally designed template on the select tab 27-1 (i.e., displayed under the “Your Designs” column on tab 27-1); (v) a select tool 45-5 for activating a cursor that can be used to select a particular text element 43-2 or image element 43-3 displayed on the workspace 37; (vi) a zoom tab 45-6 for enlarging any section of the workspace 37 using a pop-up zoom navigator (not shown); (vii) a text tab 45-7 for adding a text box to the active workspace 37; (viii) a photo tab 45-8 for adding a picture to the active workspace 37; (ix) a clipart tab 45-9 for adding a piece of clipart to the active workspace 37; and (x) a background tab 45-10 for selecting and downloading a background to replace the active background element 43-1 on the active workspace 37.

When the design process for the active file has been completed, the user proceeds by activating 3D preview tab 27-3. Referring now to FIG. 2(d), there is shown a sample screen display 47 of the active file with 3D preview tab 27-3 shown open. As can be seen, program 23 creates both (i) a three-dimensional rendering 49 of the active file and (ii) a pair of graphical user interface (GUI) controls 51-1 and 51-2 in the form of directional arrows that enable the user to rotate the three-dimensional rendering 49 about its longitudinal or vertical axis in the left and right directions, respectively. As can be appreciated, the software application 23 provides the user with an accurate three-dimensional electronic depiction of how the active file will appear when printed on the intended office product.

If the user is unsatisfied with any aspect of the custom design, the create tab 27-2 can be re-opened to allow for further editing of the active file. To the contrary, if the user is satisfied with the design, a check out tab 53 can be activated, which, in turn, opens order tab 27-4. Referring now to FIG. 2(e), there is shown a sample screen display 55 of a fillable order form, which can be completed by the user/customer 15 and submitted to product manufacturer 13 with the active file. By converting the active file into a print-ready file format, manufacturer 13 can easily proceed with execution of the custom print order.

As will be described in detail below, the software application 23 is provided with a pair of novel tools that serve to dramatically assist the user in the design process. Specifically, the software application 23 is provided with a panel selection tool 57 and an image size optimization tool, each of the tools to be described in detail below.

### Panel Selection Tool

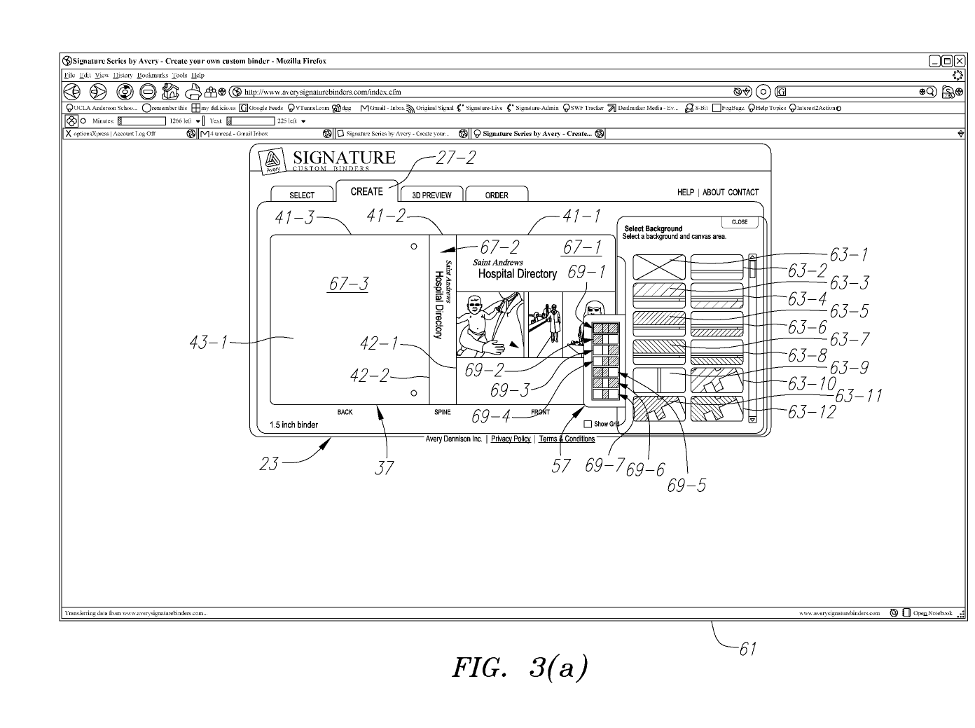

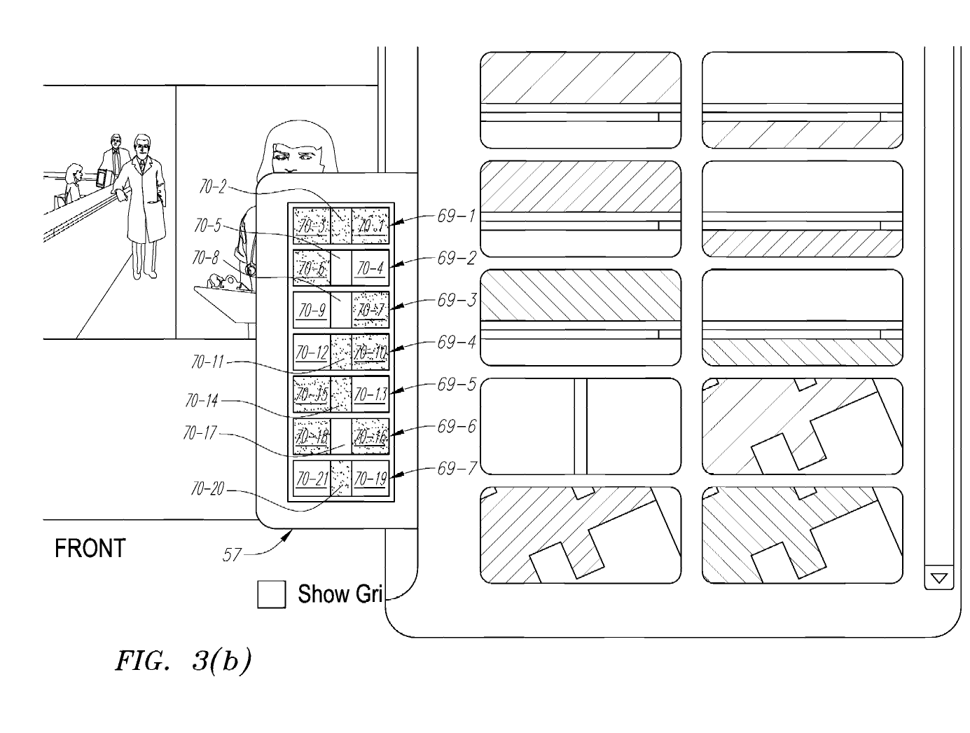

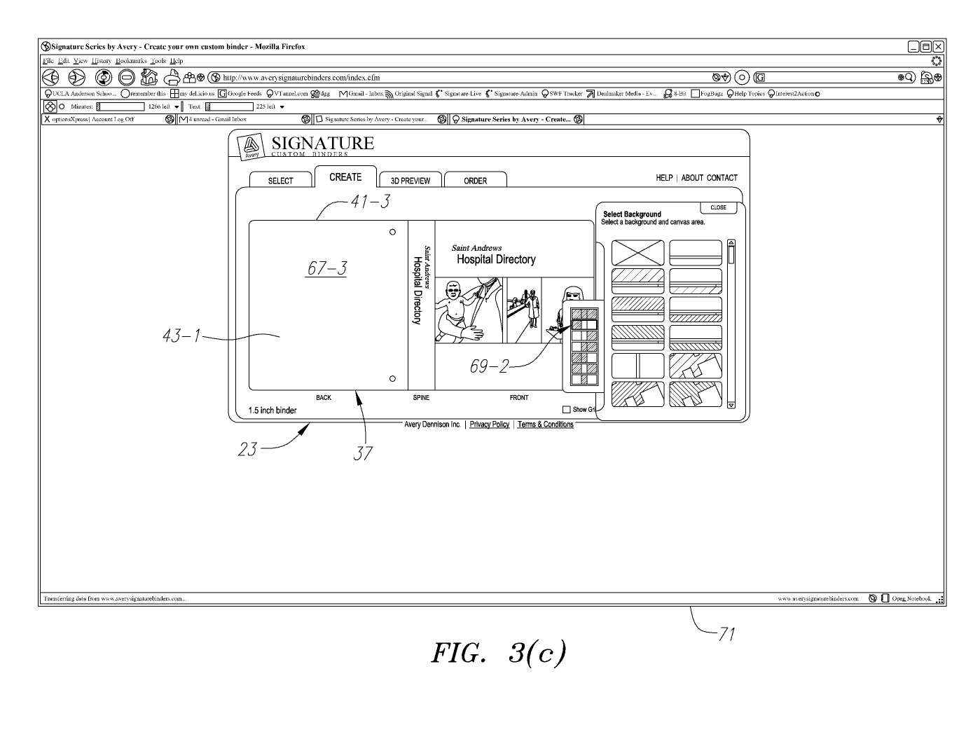

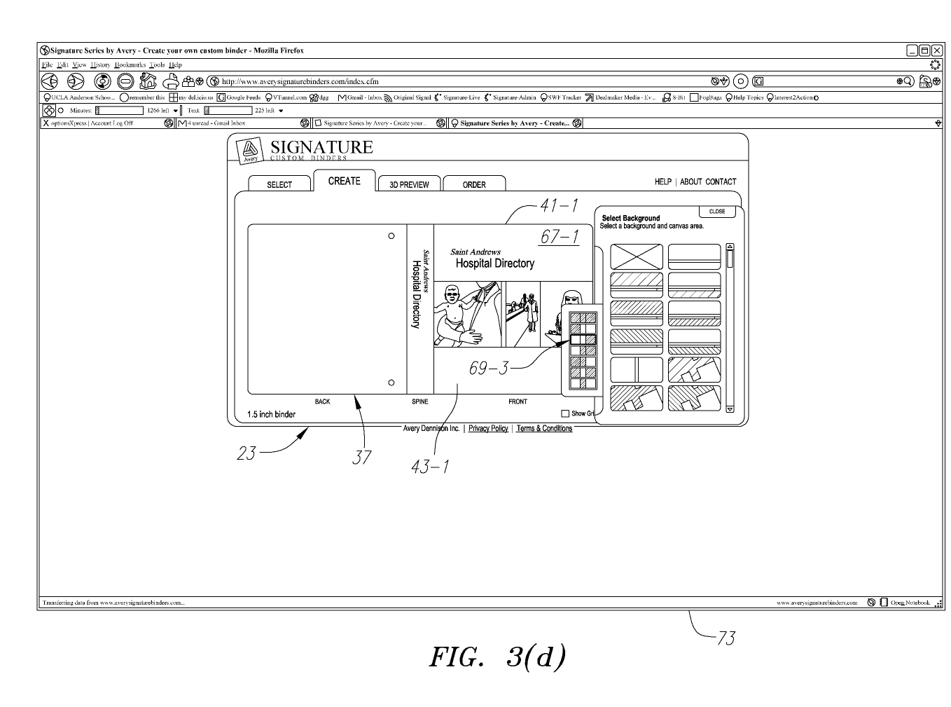

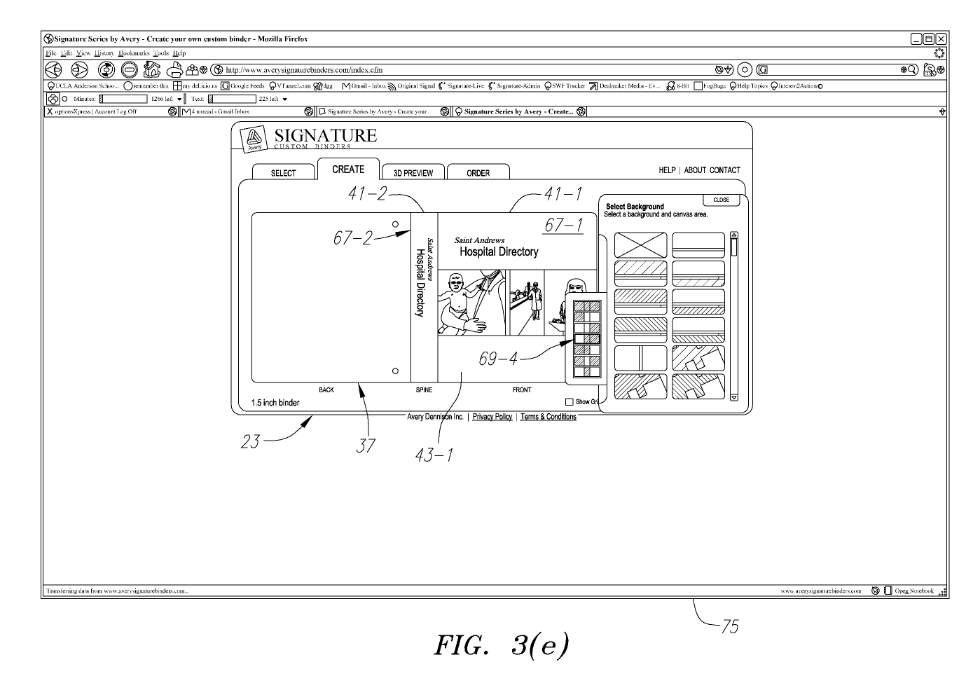

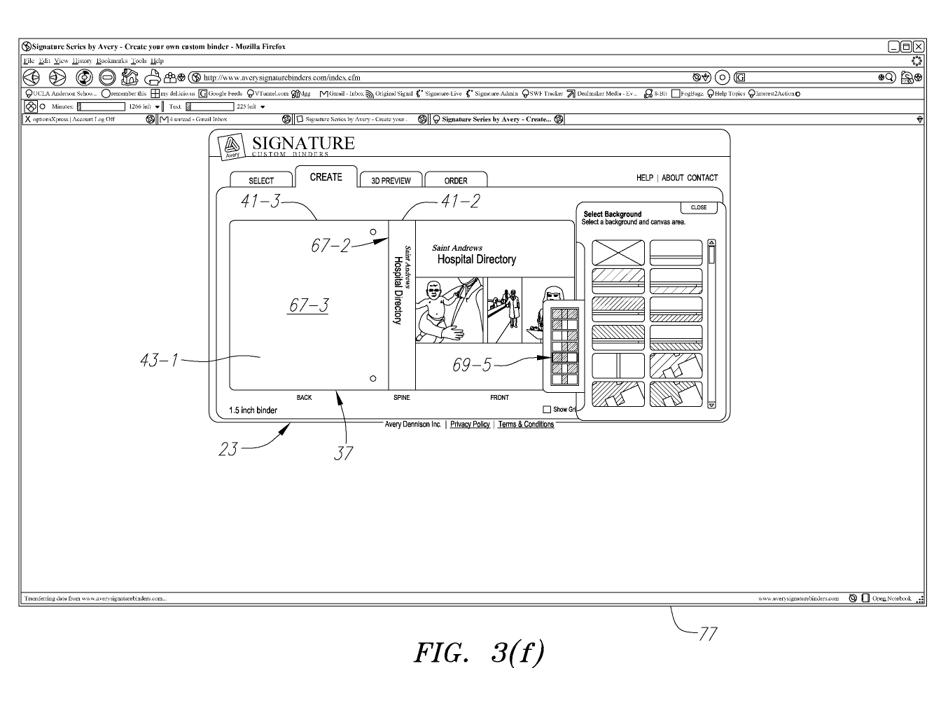

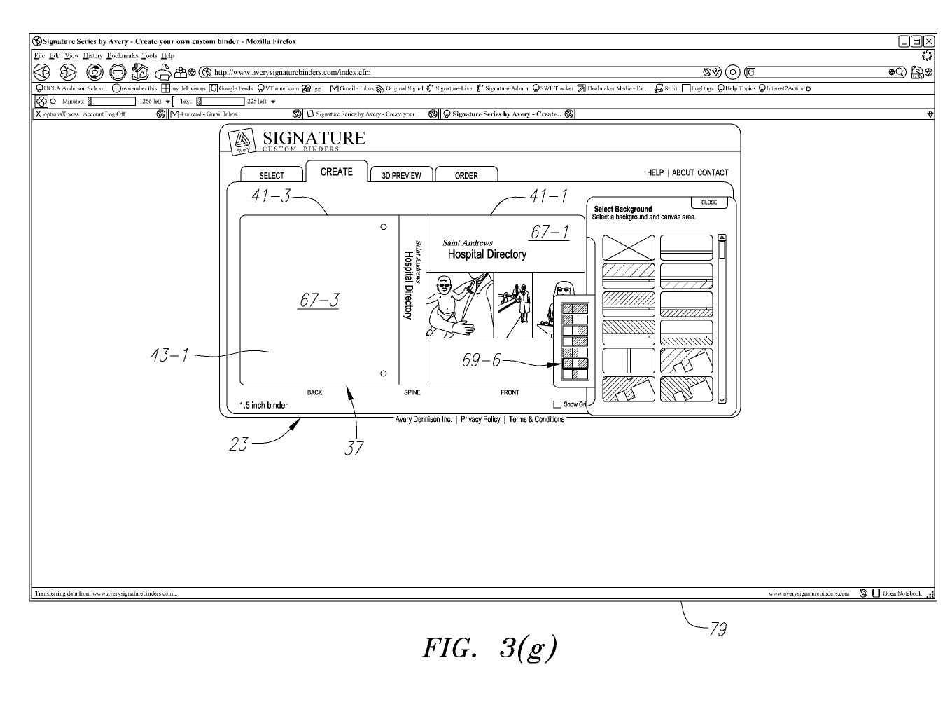

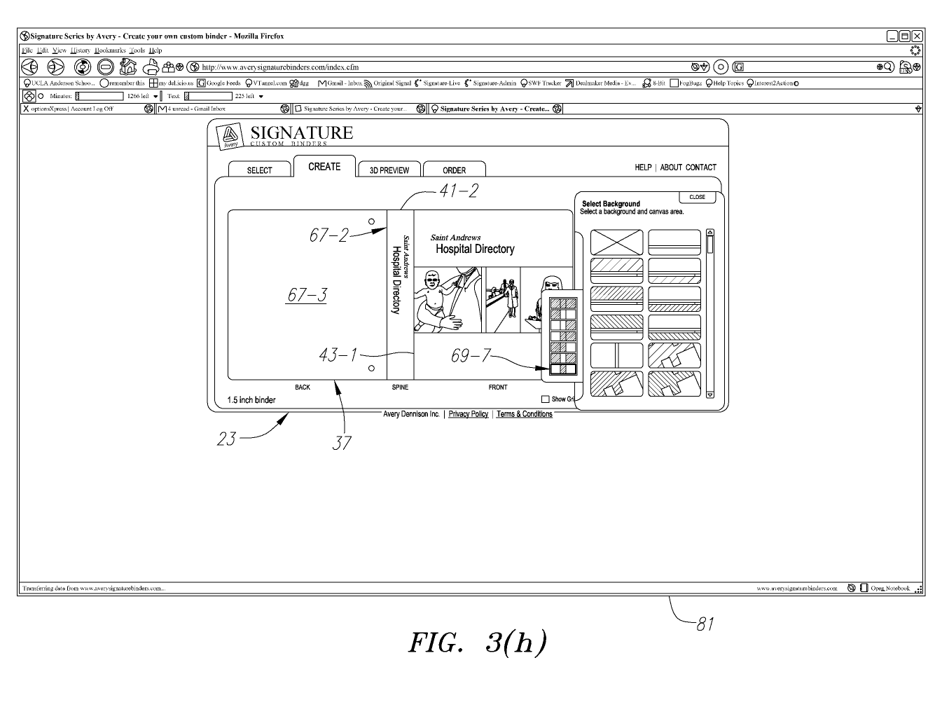

Referring now to FIGS. 3(a)-(g), there are shown a series of sample screen displays that are useful in understanding the functionality of a panel selection tool 57. As will be described further below, the software application 23 partitions any design element 43 (e.g., the background element 43-1, the text element 43-2 and/or the image element 43-3) that extends across multiple panels 41 of the active workspace 37 into a plurality of discrete subsections, the software application 23 partitioning the design element 43 through the one or more partition lines 42 that separate the multiple panels 41. Additionally, the multiple panels can be non-adjacent, having an intervening blank or unused panel. In turn, the panel selection tool 57 is activated that enables the user to readily control the display of any combination of the subsections of the design element 43 within the workspace 37.

Specifically, as shown in FIG. 3(a), there is shown a sample screen display 61 of the active file shown in FIG. 2(b), the screen display 61 being shown with the create tab 27-3 opened and with the background button 45-10 (as seen most clearly in FIG. 2(b)) selected. As can be seen, the selection of the background button 45-10 retrieves an array of alternative background patterns 63-1 thru 63-12, which are available for selection. In addition, the selection of the background button 45-10 activates the panel selection tool 57, the function of which will be described further in detail below.

Because the background element 43-1 in the active file extends across multiple panels 41, the software application 23 partitions the background element 43-1 through partition lines 42-1 and 42-2 and into a plurality of discrete subsections 67-1, 67-2 and 67-3. As can be appreciated, subsection 67-1 corresponds to the portion of the background element 43-1 displayed in the front panel 41-1 of the workspace 37, subsection 67-2 corresponds to the portion of the background element 43-1 displayed in the spine panel 41-2 of the workspace 37, and subsection 67-3 corresponds to the portion of the background element 43-1 displayed in the back panel 41-3 of the workspace 37.

As noted above, selection of the background button 45-10 activates the panel selection tool 57. As can be seen, the panel selection tool 57 is represented herein as a graphical user interface (GUI) control that automatically pops-up on the workspace 37, the GUI control being in the form of a grid, or table, of uniquely patterned rows 69.

In FIG. 3(b), the panel selection tool 57 shown in FIG. 3(a) is enlarged for greater ease in viewing. As can be seen, each row 69 of the panel selection tool 57 is displayed as a rectangular box that is partitioned into three distinct subsections so as to closely resemble the formatting attributes (i.e., the panels 41) of the active workspace 37 in miniaturized form, the individual subsections being identified herein by reference numerals 70-1 thru 70-21.

Each subsection 70 in each row 69 is represented either as shaded or white. If the subsection 70 of a row 69 is represented as shaded, it is to be understood that the particular subsection of the background element 43-1 that is present within the corresponding panel 41 of the workspace 37 is to be displayed. To the contrary, if the subsection 70 of a row 69 is represented as white, it is to be understood that the particular subsection of the background element 43-1 that is present within the corresponding panel 41 of the workspace 37 is not to be displayed with the remainder of the panel 41.

As can be appreciated, the subsections 70 of each row 69 are uniquely shaded in every conceivable combination. In this manner, the user can easily control the display of an element 43 within certain panels 41 of the workspace 37 by clicking on a particular row 69 of the panel selection tool 57.

Specifically, in the present example, the panel selection tool 57 includes (i) a first row 69-1 that is patterned to display the background element 43-1 within all panels 41 of the workspace 37 (as shown in FIG. 3(a)), (ii) a second row 69-2 that is patterned to display the background element 43-1 only within the rear panel 41-3 of the workspace 37 (as shown in the sample screen display 71 provided in FIG. 3(c)), (iii) a third row 69-3 that is patterned to display the background element 43-1 only within the front panel 41-1 of the workspace 37 (as shown in the sample screen display 73 provided in FIG. 3(d)), (iv) a fourth row 69-4 that is patterned to display the background element 43-1 only within the front panel 41-1 and the spine panel 41-2 of the workspace 37 (as shown in the sample screen display 75 provided in FIG. 3(e)), (v) a fifth row 69-5 that is patterned to display the background element 43-1 only within the spine panel 41-2 and the rear panel 41-3 of the workspace 37 (as shown in the sample screen display 77 provided in FIG. 3(f)), (vi) a sixth row 69-6 that is patterned to display the background element 43-1 only within the front panel 41-1 and the rear panel 41-3 of the workspace 37 (as shown in the sample screen display 79 provided in FIG. 3(g)), and (vii) a seventh row 69-7 that is patterned to display the background element 43-1 only within the spine panel 41-2 of the workspace 37 (as shown in the sample screen display 81 provided in FIG. 3(h)).

It should be noted that the panel selection tool 57 is not limited to the particular number and pattern of subsections 70 and/or rows 69 shown herein. Rather, it is to be understood that the number and pattern of subsections 70 and/or rows 69 could be modified as deemed necessary without departing from the spirit of the present invention. For example, a workspace with only two panels or an element that extends across only two panels would only require a panel selection tool with three uniquely patterned rows to simulate the various panel selection combinations.

It should also be noted that the panel selection tool 57 is not limited to use in conjunction with the background element 43-1. Rather, it is to be understood that the panel selection tool is designed to similarly activate when a selected text element 43-2 or image element 43-3 extends across multiple panels 41 of the workspace 37.

### Image Size Optimization Tool

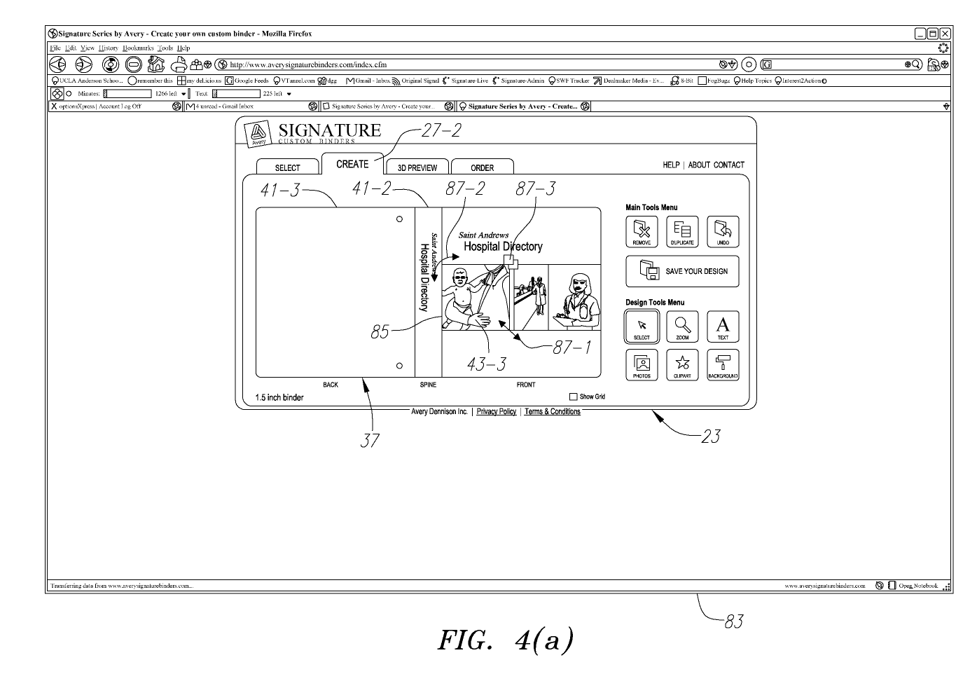

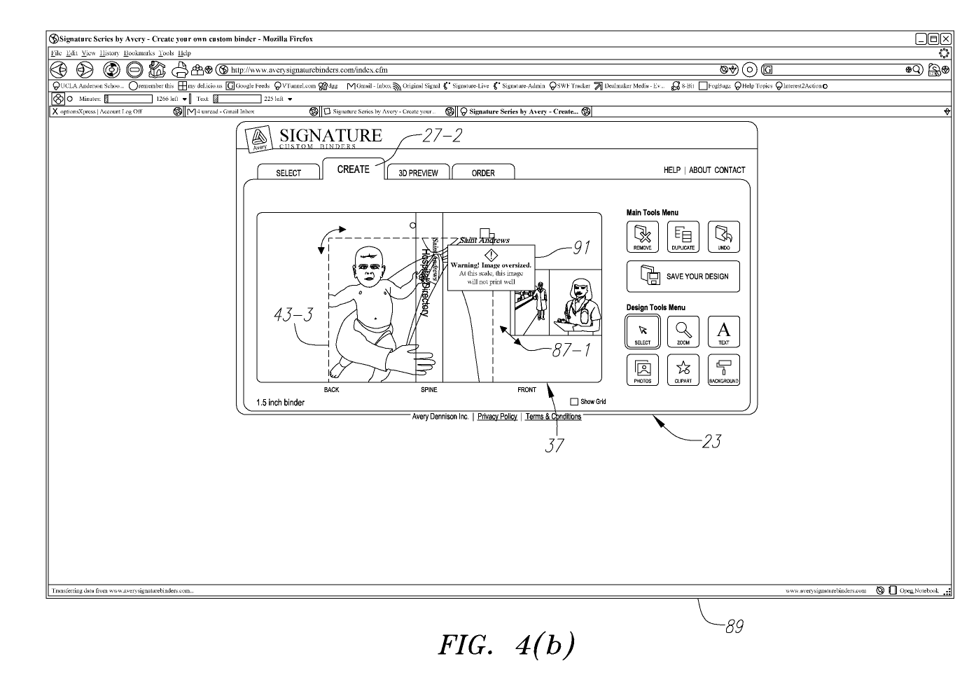

Referring now to FIGS. 4(a) and 4(b), there is shown a pair of sample screen displays that are useful in understanding the functionality of the image size optimization tool of the present invention. As will be described further below, the image size optimization tool ensures that the resolution of each image element 43-3 on the active workspace 37 is maintained above a particular standard.

Specifically, as shown in FIG. 4(a), there is shown a sample screen display 83 of the active file shown in FIG. 2(b), the screen display 83 being shown with the create tab 27-3 opened and the photo element 43-3 selected. As noted briefly above, the selection of a particular image element 43-3 on the workspace 37 activates a visible picture box 85 around the image element 43-3 along with a plurality of image related controls 87 including, but not limited to, an image resizing tool 87-1, an image rotation tool 87-2 and an image order tool 87-3 (i.e., for moving the image box forward or backward in relation to other elements).

It is to be understood that by clicking on the image resizing tool 87-1, the user is able to resize the image element 43-3 using a fixed aspect ratio. Specifically, while the image resizing tool 87-1 is clicked, outward displacement of the cursor (i.e., away from the center of the picture) causes the image element 43-3 to incrementally increase in size, and the inward displacement of the cursor (i.e., in towards the center of the picture) causes the image element 43-3 to incrementally decrease in size.

It should be noted that certain image elements 43-3 may appear to be of a satisfactory resolution when depicted on the workspace 37. However, it has been found that when the image elements 43-3 are actually printed onto office products, the resolution of the image elements 43-3 falls beneath an acceptable threshold.

Accordingly, the image size optimization tool of the present invention monitors the resolution of each image element 43-3 displayed on the workspace 37 and compares the resolution against a predefined resolution threshold of approximately 180 dots per square inch (dpi). As can be seen most clearly in the sample screen display 89 shown in FIG. 4(b), if an image element 43-3 displayed on the workspace 37 exceeds the predefined threshold, a warning box 91 is activated that pops-up on the workspace 37, thereby notifying the user that the image element 43-3 is presently oversized. In this manner, the user is ensured that all image elements 43-3 in the active file will print at an acceptable level, which is highly desirable.

It should be noted that the image size optimization tool is not limited to the use of a resolution threshold of approximately 180 dpi. Rather, it is to be understood that the resolution threshold utilized by the image size optimization tool could be increased or decreased without departing from the spirit of the present invention.

The embodiments shown in the present invention are intended to be merely exemplary and those skilled in the art shall be able to make numerous variations and modifications to them without departing from the spirit of the present invention. For example, in the case of a customized binder, the customization can be done on the outside of the binder, the inside of the binder or on both the inside and outside of the binder. All such variations and modifications are intended to be within the scope of the present invention as defined in the appended claims.

What is claimed is:

1. A method of creating an electronic document to be used in the customized design of a printable office product, the method being implemented using a software application, the printable office product including first and second printable surfaces, the method comprising the steps of:
(a) opening an active file within the software application, the active file capable of supporting a visual element,
(b) rendering a workspace for the active file within the software application, the workspace being formatted into first and second panels that correspond to the first and second printable surfaces of the printable office product, the first and second panels being separated by a partition line, the workspace including a visual element that extends across the partition line, the software application partitioning the visual element through the partition line and into first and second subsections, and
(c) activating a panel selection tool within the software application, the panel selection tool regulating the display of any combination of the first and second subsections of the visual element within the workspace.

2. The method of claim 1, wherein the panel selection tool generates a graphical user interface (GUI) control for regulating the display of any combination of the first and second subsections of the visual element within the workspace.

3. The method of claim 2, wherein the panel selection tool generates a GUI control in the form of a grid of uniquely patterned rows, each row serving as an active control for displaying a unique combination of the first and second subsections.

4. The method of claim 3, wherein each row of the GUI control for the panel selection tool is displayed as a box that is partitioned into a pair of subsections so as to resemble the formatting attributes of the workspace in miniaturized form.

5. The method of claim 4, wherein the subsections of each row of the GUI control are displayed as exactly one of shaded and white.

6. The method of claim 1, wherein the software application is designed to generate a three-dimensional rendering of the active file displayed on the workspace.

7. The method of claim 6, wherein the software application provides a pair of graphical user interface controls for rotating the three-dimensional rendering.

8. The method of claim 1, wherein the visual element represents one of a background element, a text element and an image element.

9. The method of claim 1, further comprising the step of, after the activating step, saving the active file depicted in the workspace of the software application to yield the electronic document to be used in the customized design of the printable office product.

10. The method of claim 1, further comprising the steps of, prior to the opening step:
(a) accessing a centralized server having stored thereon the software application for creating the electronic document,
(b) downloading the software application from the centralized server to a customer computer, and
(c) executing the software application within a web browser in the customer computer to create the electronic document.

11. The method of claim 1, wherein the visual element is in the form of an image element, the image element having a measurable resolution.

12. The method of claim 11, wherein the software application includes controls for resizing the image element.

13. The method of claim 12, further comprising the steps of, after the rendering step:
(a) comparing the measurable resolution of the image element against a predefined resolution threshold, and
(b) generating a warning indicator on the workspace when the resolution of the image element falls beneath the predefined resolution threshold.

14. The method of claim 13, wherein the predefined resolution threshold is approximately 180 dpi.

15. The method of claim 1, wherein the software application includes controls that are configured to act upon the first subsection of the visual element.

16. A method of creating an electronic document to be used in the customized design of a printable office product, the method being implemented using a software application, the method comprising the steps of:
(a) opening an active file within the software application, the active file capable of supporting an image element,
(b) rendering a workspace for the active file within the software application, the workspace including an image element, the image element having a measurable resolution, the software application including controls for resizing the image element,
(c) comparing the measurable resolution of the image element against a predefined resolution threshold, and
(d) generating a warning indicator on the workspace when the resolution of the image element falls beneath the predefined resolution threshold.

17. The method of claim 16, wherein the predefined resolution threshold is approximately 180 dpi.
